(19) United States
(12) Patent Application Publication
(10) Pub. No.: US 2007/0045304 A1
(43) Pub. Date: Mar. 1, 2007

(54) Food preservative device

(76) Inventor: Hsiao-Hua Liang, Nantou Hsien (TW)

Correspondence Address: Troxell Law Office PLLC, Suite 1404, 5205 Leesburg Pike, Falls Church, VA, 22041, US

(21) Appl. No.: 11/195,760

(22) Filed: Aug. 3, 2005

(51) Int. Cl. H05B 6/80

(52) U.S. Cl. 219/735

(57) ABSTRACT

A food preservation device has a cover made of silicone and a valve mounted through the cover, and the cover includes a plate with a skirt. The valve has a T-shaped air passage. The silicone cover has flexibility and elasticity, and further possesses heat resistance feature whereby food can be heated in a micro-wave oven or bamboo steamer, and the T-shaped air passage communicates with ambient air, whereby the container will not accumulate excessive heat, nor will fluid in the food splash out.

### BACKGROUND OF THE INVENTION

1. Field of the Invention

The present invention relates to a food preservative device, and particularly relates to a food preservative device which has excellent flexibility and elasticity, and can be reused.

2. Description of Related Art

Preservative film is commonly used for keeping the food fresh, and the general preservative film is made of transparent plastic and encircles a cylindrical tube, then the preservative film is extracted a certain amount when required for use. In addition, to prevent the water, oil, etc. of food from splashing out, users normally heat the food in a microwave oven or a bamboo steamer with the preservative film thereon. However, most preservative film is made of PVC (polyvinyl chloride) and PP (Polypropylene), and the heat resistance temperatures of PVC and PP are respectively 60 degrees Celsius and 135 degrees Celsius. If the preservative film made of PVC is heated with the food, a dangerous chemical composition, chlorethylene will be released, which creates the possibility of cancer to anyone consuming food prepared in this way. Although the heat resistance temperature of the PP is comparatively higher than that of the PVC, the preservative film tends to melt when the temperature is above 135 degrees Celsius.

Besides, the heat and steam between the food and the preservative film can not be dissipated, whereby the heat will lift the preservative film from the food and the microwave oven interior will be contaminated. Additionally, the preservative film can not be used again, which is not favorable to environmental protection. If the food is put in the refrigerator for a couple of days, users may forget the storage life of the food or when the food was first put in, and the old food is unhealthy or unappetizing.

Therefore, the invention provides a food preservative device to mitigate or obviate the aforementioned problems.

### SUMMARY OF THE INVENTION

The main objective of the present invention is to provide a food preservative device that includes a cover made of silicone and a valve mounted through the cover. The cover has not only excellent flexibility and elasticity, but also possesses a thermo-tolerant feature that permits heating of food in a micro-wave oven or bamboo steamer, and the cover can closely contact with a food container, and the valve can release the heat and steam in time, which prevents the water, oil, etc of the food from splashing. Furthermore, the food preservative device is favorable to environmental protection and saves the related resources.

An indicator encircles the valve between the top member of the valve and an anti-deformation member, a pointer is mounted on the indicator, and marks are provided on the indicator and the anti-deformation member, which can be set by the user to indicate a shelf-life period of the food or when the food was first sealed, and the food preserved for an excessively long time will not be eaten by mistake.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of the food preservative device in accordance with this invention;

FIG. 2 is a partial exploded view of the food preservative device in accordance with this invention;

FIG. 3 is a cross sectional plan view of the food preservative device when in use in accordance with this invention;

FIG. 4 is a cross sectional plan view of the food preservative device of this invention when the food is isolated from the ambient environment;

FIG. 5 is a cross sectional plan view of the food preservative device of this invention when the T-shaped air passage communicates with the ambient environment;

FIG. 6 is a perspective view of another embodiment of the food preservative device in accordance with this invention.

### DETAILED DESCRIPTION OF THE PREFERRED EMBODIMENT

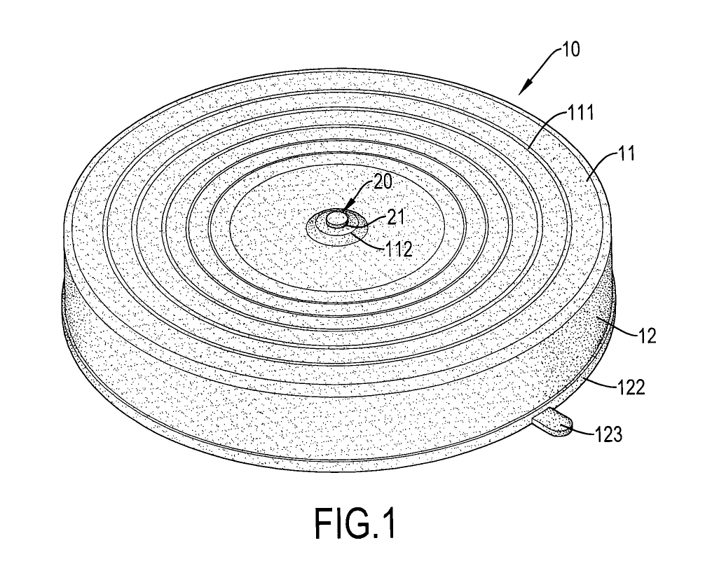

With reference to FIGS. 1-3, a food preservative device has a cover (10) made of silica-gel and a valve (20) extended through the cover (10). The cover (10) includes a plate (11), around which a skirt (12) is formed. The cover (10) can be round, oval, rectangular etc. and cooperates with the containers of different shapes. In this embodiment, the cover (10) is round. The plate (11) has a flexible undulations (111) formed thereon, and the undulations (111) are co-axially arranged, so the plate (11) can be deformed by squeezing or extending the flexible undulations (111) depending on the area of food or container (50). An anti-deformation member (112) is provided in the center of the plate (11), and is thicker than the plate (11). A hole (13) is defined in the center of the anti-deformation member (112) for the valve (20) to be mounted therethrough, and an inside periphery of the hole (13) expands upwards, so a round chamfer (131) is formed in the hole (13).

A mating surface (121) with multiple ribs is formed on an inner wall of the skirt (12), whereby the skirt (12) is closely fitting with the container (50). In addition, a tightening edge (122) is formed on the skirt (12) to enhance the contact between the skirt (12) and the container (50). At least one ear (123) is extended from the tightening edge (122) to facilitate pulling of the cover away from the container (50).

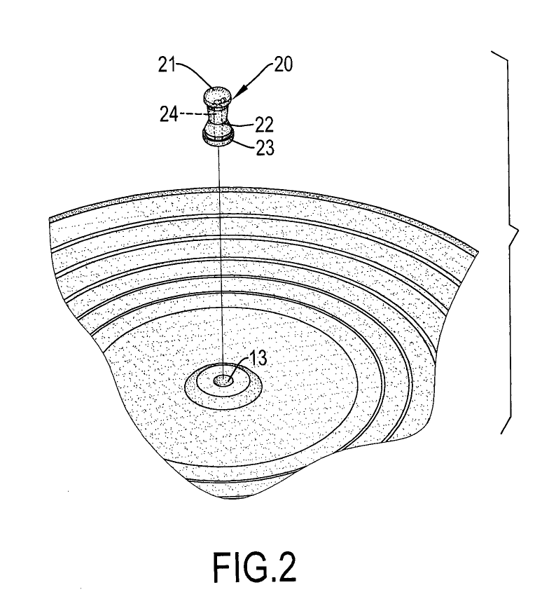

With reference to FIGS. 2-4, the valve (20) is formed as a dumbbell shape having a top member (21), a neck (22) and a bottom member (23). The top member (21) protrudes from the cover (10) and a diameter of the top member (21) is bigger than the hole (13); the neck (22) is snugly received in the hole (13) and is a little longer than the hole (13); and the bottom member (23) protrudes below the cover (11) and a diameter of the bottom member (23) is bigger than the hole (13). A T-shaped air passage (24) is defined from the neck to the bottom member of the valve (20) and selectively communicates an exterior and an interior of the cover (10). A top portion of the neck (22) is shaped as a truncated cone and corresponds to the hole (13) and a bottom portion of the neck is shaped as a bell.

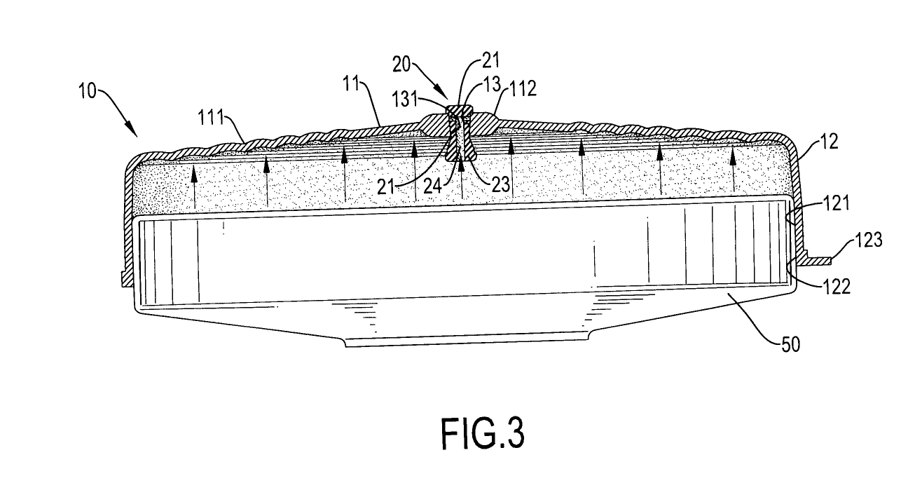

With reference to FIG. 1 and FIG. 3 again, the cover (10) and the valve (20) are both made of silica-gel, which not only has excellent flexibility and elasticity, but also possesses a heat resistance feature such that food can be heated in a micro-wave oven or bamboo steamer, which solves the problem of the contemporary preservative film.

In operation, the user just covers an opening of the container (50) with the food preservative device when necessary, which is simple and convenient, besides, the food preservative device made of the silica-gel can be washed and reused, which is favorable to environmental protection. Furthermore, the silica-gel can endure high temperatures.

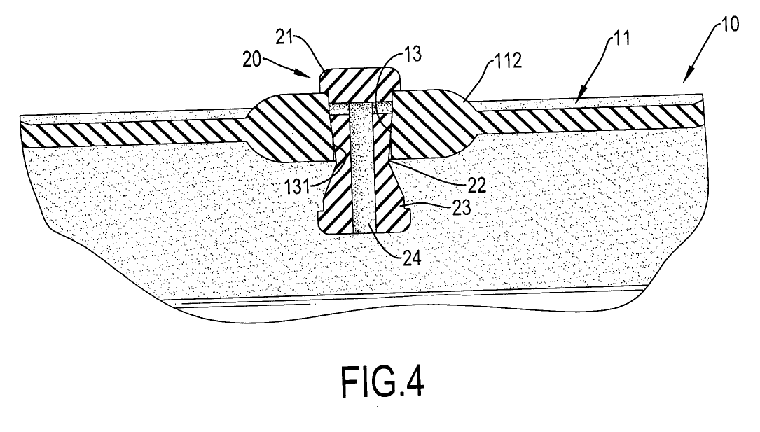

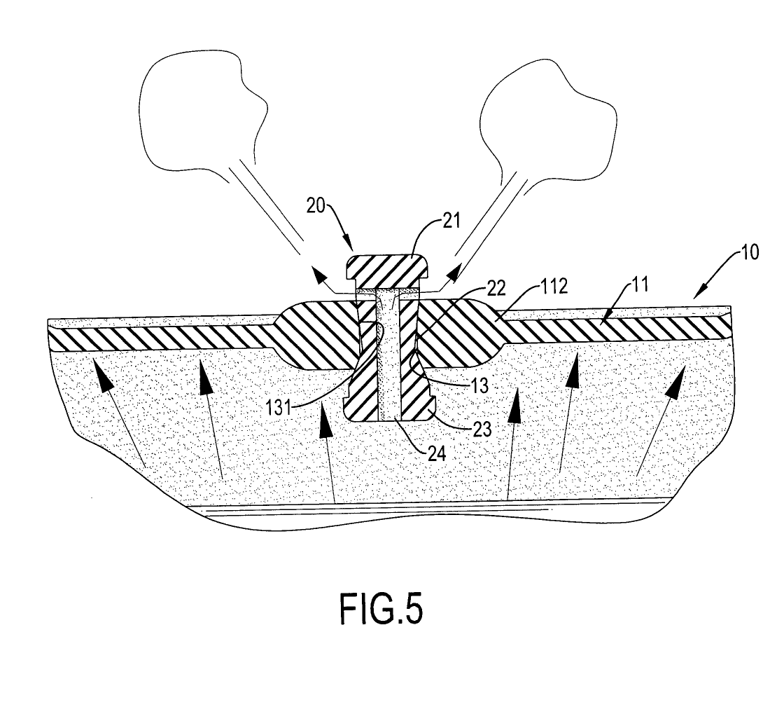

With reference to FIG. 3 and FIG. 4, the cover (10) is mounted over the opening of the container (50), the valve (20) is pressed down such that the T-shaped air passage (24) is closed by the round chamfer (131). The food in the container (50) is isolated from the ambient air and kept fresh for a long time. With reference to FIG. 3 and FIG. 5, when the food is heated, the valve (20) is pulled up, and the T-shaped air passage (24) communicates with the ambient air to act as a vent, whereby the container will not accumulate excessive heat, and fluids in the food will not splash out.

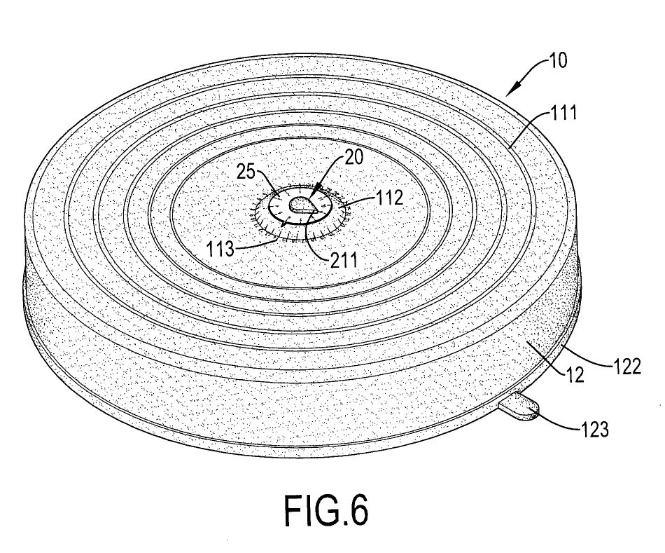

FIG. 6 shows another embodiment of this invention. An indicator (25) encircles the valve (22) between the top member (21) of the valve (20) and the anti-deformation member (112), and a pointer (211) is mounted on the indicator (25). Marks (113) are provided on the indicator (25) and the anti-deformation member (112). Thus, the user can set pointer to indicate preferred maximum storage period of the food whereby the food preserved for an excessive amount of time will not be eaten by mistake.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A food preservative device for sealably mounting over a food receptacle, comprising:
a flexible cover (10) made of silicone and including a plate (11), a skirt (12) formed around the plate (11), and a hole (13) defined in the plate (11); and
a valve (20) mounted through the hole (13), and an air passage (24) defined in the valve (20),
whereby in a non-heating status, the valve (20) is pressed down and the air passage (24) is isolated from the ambient air, and in a heating status, the valve (20) is pulled up, and air passage (24) communicates with the ambient air.

2. The food preservative device as referred in claim 1, wherein the plate (11) is round, and an anti-deformation member (112) is provided in the center of the plate (11), and the hole (13) is defined in the anti-deformation member (112).

3. The food preservative device as referred in claim 2, wherein at least one flexible undulation (111) is formed on the plate (11).

4. The food preservative device as referred in claim 3, wherein the at least one flexible undulation (111) comprises multiple co-axial undulations.

5. The food preservative device as referred in claim 3, wherein a mating surface (121) is formed on an inner wall of the skirt (12).

6. The food preservation device as referred in claim 5, wherein the mating surface (121) has multiple ribs.

7. The food preservation device as referred in claim 5, wherein a tightening edge (122) is formed on the skirt (12).

8. The food preservation device as referred in claim 7, wherein the valve (20) is formed as a dumbbell shape having a top member (21), a neck (22) and a bottom member (23); wherein the top member (21) is protrudes above the cover (10) and a diameter of the top member (21) is bigger than the hole (13); the neck (22) is snugly received in the hole (13) and is longer than the hole (13); and the bottom member (23) protrudes below the cover (11) and a diameter of the bottom member (23) is bigger than the hole (13).

9. The food preservation device as referred in claim 8, wherein the air passage (24) is defined from the neck to the bottom member of the valve (20) and communicates with a container (50).

10. The food preservation device as referred in claim 9, wherein an inside diameter of the hole (13) is formed as an outward, upward taper (131); a top portion of the neck (22) is formed as a truncated cone corresponding to the hole (13) and a bottom portion of the neck is formed as a bell shape.

11. The food preservation device as referred in claim 10, wherein at least one ear (123) is extended from the tightening edge (122).

12. The food preservation device as referred in claim 1, wherein an indicator (25) encircles the valve (22) and is formed between the top member (21) of the valve (20) and the anti-deformation member (112), a pointer (211) is mounted on the indicator (25), and marks (113) are provided on the indicator (25) and the anti-deformation member (112).

13. The food preservation device as referred in claim 1, wherein at least one flexible undulation (111) is formed on the plate (11) and comprises multiple co-axial undulations.

14. The food preservation device as referred in claim 1, wherein a mating surface (121) is formed in an inner wall of the skirt (12) and having multiple ribs.

15. The food preservation device as referred in claim 1, wherein a tightening edge (122) is formed on the skirt (12).

16. The food preservation device as referred in claim 1, wherein the valve (20) is formed as a dumbbell shape having a top member (21), a neck (22) and a bottom member (23); the top member (21) protruding above the cover (10) and a diameter of the top member (21) is bigger than the hole (13); the neck (22) is snugly received in the hole (13) and is longer than the hole (13); and the bottom member (23) protrudes below the cover (11) and a diameter of the bottom member (23) is bigger than the hole (13).

17. The food preservation device as referred in claim 16, wherein the air passage (24) is defined from the neck to the bottom member of the valve (20) to be adapted to communicate with the container (50).

18. The food preservation device as referred in claim 15, wherein at least one ear (123) is extended from the tightening edge (122).

19. The food preservation device as referred in claim 16, wherein an inside diameter of the hole (13) is formed as an outward, upward taper (131); a top portion of the neck (22) is formed as a truncated cone corresponding to the taper (131), and a bottom portion of the neck is formed as a bell shape.
